(19) United States
(12) Patent Application Publication
(10) Pub. No.: US 2010/0281402 A1
(43) Pub. Date: Nov. 4, 2010

(54) SOFTWARE-BASED ASYNCHRONOUS TILED BACKINGSTORE

(75) Inventors: George Ross Staikos, Toronto (CA); Adam Chester Treat, Hanover, NH (US); Yong Li, Toronto (CA)

Correspondence Address: Ogilvy Renault LLP- RIM, 1 Place Ville Marie, Suite 2500, Montreal, QC, H3B 1R1, CA

(73) Assignee: TORCH MOBILE INC., Toronto (CA)

(21) Appl. No.: 12/770,247

(22) Filed: Apr. 29, 2010

Related U.S. Application Data
(60) Provisional application No. 61/173,843, filed on Apr. 29, 2009.

(51) Int. Cl. G06F 3/048

(52) U.S. Cl. 715/760

(57) ABSTRACT

Systems, methods, devices, and programming product for displaying on a computer screen (200) a portion of a web page or other interface screen content (400), the methods performed by processors and comprising: accessing a data set representing display content (400) for a computer interface screen (200); mapping the accessed data set into a plurality of tiled content data sets; selecting a portion of the tiled content data set to be rendered into tiled image data set; rendering the selected portion of the tiled content data set into a plurality of tiled image data sets (510); and storing the set of tiled image data sets in a memory (700) controlled by the processor.

### CROSS-REFERENCE TO RELATED APPLICATION

This application claims priority from U.S. Provisional Application No. 61/173,843, filed Apr. 29, 2009, the entirety of which is hereby incorporated by reference.

### TECHNICAL FIELD

The present disclosure provides devices, systems, methods, and computer programming product for displaying on a computer screen an interface screen corresponding to a portion of a web page or other display content data. In particular, there are provided devices, systems, methods, and computer programming products for implementing pseudo-asynchronous tiled backingstore processes in rendering image or other content in hardware-limited devices.

### BACKGROUND

The use of handheld computer devices to view Internet web pages is typically subject to inherent limitations. For example, a handheld device is typically incapable of legibly rendering the content of a computer interface screen content such as an Internet web page in the same manner, or to the same extent, as a typical desktop PC. If for example Internet browsing software operating on a handheld device were to attempt to immediately render the entire Internet content associated with a typical web page directly to the computer screen of a handheld device upon receiving user interface events or content changes, due to the limited hardware capabilities of the handheld device, the attempt could result in a blockage of the user interface and make it very unresponsive and hard for the user to operate. In addition, the limited hardware capabilities of handheld devices are typically not sufficient to provide a user with a smooth and comprehensible scrolling experience using commercial available rendering engines alone, such as for example, Webkit™.

In today's market, users are clamoring for mobile Internet browsers to show the exact same content (or as close as possible) on their handheld device that they would otherwise see on their desktop device. Since desktop devices are usually much more powerful and provide a much larger screen size, this means that today's web developers design sites optimized to work with the powerful hardware and large screens utilized on desktop devices without regard to how these Internet sites might be viewed on handheld devices. This creates a difficult software challenge for creators of mobile Internet browsers, namely, how to create a browser that will display such modern complex desktop-focused Internet pages and still provide an acceptable user experience.

Commercially-available rendering engines utilized by Internet browsers on handheld devices typically attempt to render content as soon as it scrolls into view. This can produce a very jagged and slow scrolling experience.

There and other problems point to a need for systems, methods, devices, and programming products that improve the rendering of content on handheld devices.

### BRIEF DESCRIPTION OF THE DRAWINGS

The present disclosure is illustrated in the figures of the accompanying drawings, which are meant to be exemplary and not limiting, and in which like references are intended to refer to like or corresponding parts.

FIG. 1 is a schematic diagram of a handheld computer device comprising components suitable for use in implementing an example embodiment of the present disclosure, in relation to a conceptual model of a computer interface screen to be displayed in accordance with methods according to the present disclosure;

FIG. 2 is a conceptual illustration of an example computer memory and display content described in conjunction with descriptions of aspects of the present disclosure;

FIG. 3 is a schematic flow chart of an example embodiment of a method for displaying image data in accordance with the present disclosure;

FIG. 4 schematically illustrates example aspects of the present disclosure in relation to conceptual models of computer interface screens to be displayed in accordance with methods according to the present disclosure;

FIG. 5 shows in block diagram form another example handheld computer device suitable for implementing aspects of the present disclosure; and

FIG. 6 shows in block diagram form an example communication system suitable for providing an operating environment for implementation of aspects of the disclosure herein.

### DESCRIPTION OF EMBODIMENTS

The present disclosure provides devices, systems, methods and computer programming products useful for displaying on a display, such as a screen of a handheld or other computing device, interface screens which correspond to portions of web-page or other display content data. Such systems, devices, methods, and programming products are particularly useful in displaying such content on display screens smaller than those for which the displayed content was optimally designed.

Among other advantages, devices, systems, methods and computer programming products in accordance with the disclosure herein can provide an improved user experience utilizing only software, a general purpose central processing unit (CPU), and a general purpose operating system, and thus may not require investment in special purpose hardware and operating systems to perform the requested tasks.

Systems, devices, methods, and programming products in accordance with the disclosure can enhance user experience with Internet browsers on limited hardware utilizing memory and software only, giving improved responsiveness even when the rendering engine is busy and strained with a queue of backlogged layout and image rendering jobs.

For example, in various aspects the disclosure herein describes systems, methods, and computer programming products for displaying on a computer screen a portion of a web page or other interface display content. A method according to such aspects is performed by a data processor (such as a display control processor of a handheld computer device) and comprising: accessing a data set representing display content for a computer interface screen; mapping the accessed data set into a plurality of tiled content data sets; selecting a portion of the tiled content data set to be rendered into tiled image data sets, the selected portion of the tiled content data set having a logical relationship with each other; rendering the selected portion of the accessed tiled content data set into an a plurality of tiled image format data sets; mapping the rendered image data into a plurality of tiled image data sets; storing the set of tiled image data sets in a memory controlled by the processor; reading at least a portion of at least one of the stored tiled image data sets from the memory; and displaying at least the portion of the at least one read tiled image data set on a display.

In other aspects, there is provided a device for displaying a portion of a web page or other interface display content, the device comprising: a display for displaying image data; memory for storing image data; and a processor configured to execute instructions to cause the device to: access a data set representing display content for a computer interface screen; map the accessed data set into a plurality of tiled content data sets; select a portion of the tiled content data set to be rendered into tiled image data sets, the selected portion of the tiled content data set having a logical relationship with each other; render the selected portion of the tiled content data set into a plurality of tiled image data sets accessed data set into an image format; map the rendered image data into a plurality of tiled image data sets; store the set of tiled image data sets in the memory; read at least a portion of at least one of the stored tiled image data sets from the memory; and display at least the portion of the at least one read tiled image data set on the display.

In other aspects, there is provided a computer-readable programming product, the computer programming product having instructions tangibly encoded thereon to cause a data processor to: access a data set representing display content for a computer interface screen; map the accessed data set into a plurality of tiled content data sets; select a portion of the tiled content data set to be rendered into tiled image data sets, the selected portion of the tiled content data set having a logical relationship with each other; render the selected portion of the tiled content data set into a plurality of tiled image data sets; store the set of tiled image data sets in the memory; read at least a portion of at least one of the stored tiled image data sets from the memory; and display at least the portion of the at least one read tiled image data set on the display.

In some embodiments, the portion of the tiled content data set selected to be rendered is selected according to a static predefined logical relationship. In some embodiments, the portion of the tiled content data set to be rendered is selected according to a dynamic logical relationship. In some embodiments, the dynamic logical relationship is dynamically determined according to a prediction algorithm.

Embodiments of methods, systems, and apparatus according to the present disclosure are described through reference to the figures.

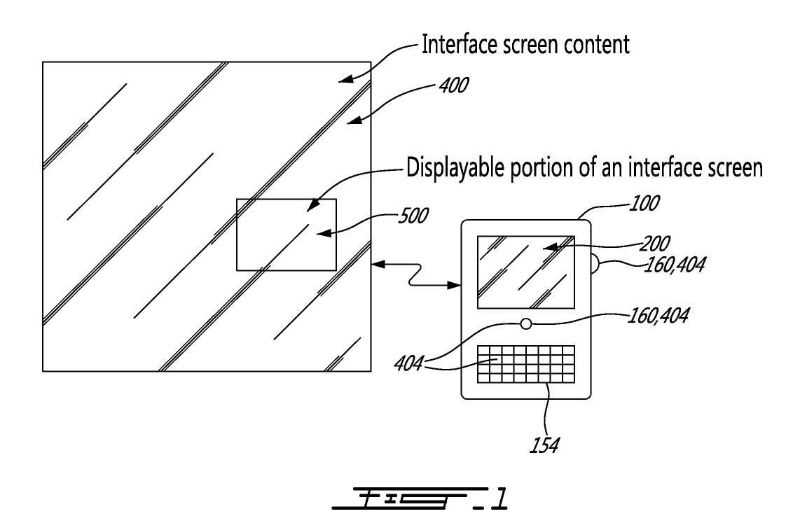

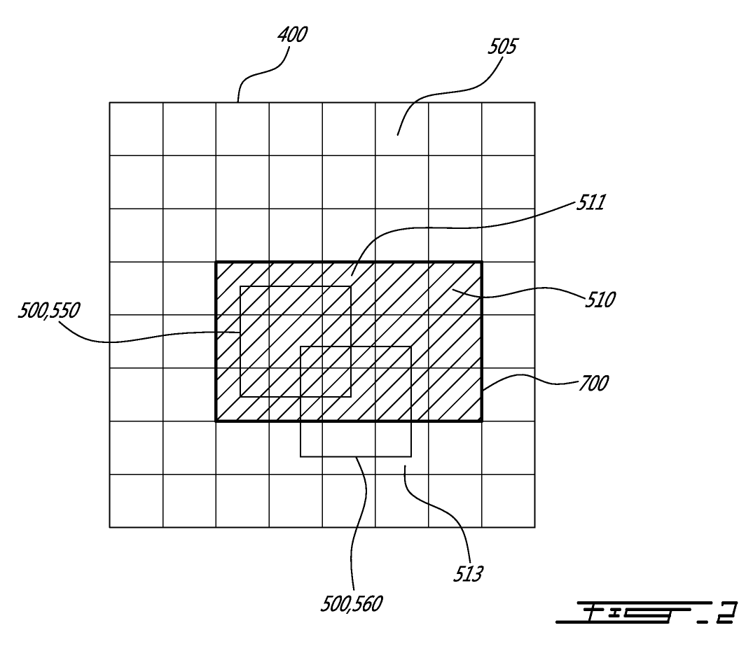

FIG. 1 is a schematic diagram of an example handheld portable computer device 100 comprising components suitable for use in implementing various embodiments of the present disclosure in relation to a conceptual model of a computer interface screen to be displayed in accordance with methods according to the present disclosure. In the embodiment shown, a handheld portable computer device 100 comprises a display which includes a computer screen 200 capable of displaying Internet web-page or other display content (i.e., any text, image or browser-type content) for viewing by a user, and memory(ies) and any other devices, components, and software required to present data, such as Internet web page, image or other content, in human-readable form. Memory provided on the handheld computer device 100 can be used as a backingstore. Device 100 further comprises one or more input devices 404, including for example but not limited to keypad 154, a touchpad (not shown), and thumbwheel and/or roller-balls 160 for use by a user in inputing user interface events, or commands, which may be interpreted by the processor as command signals and processed accordingly.

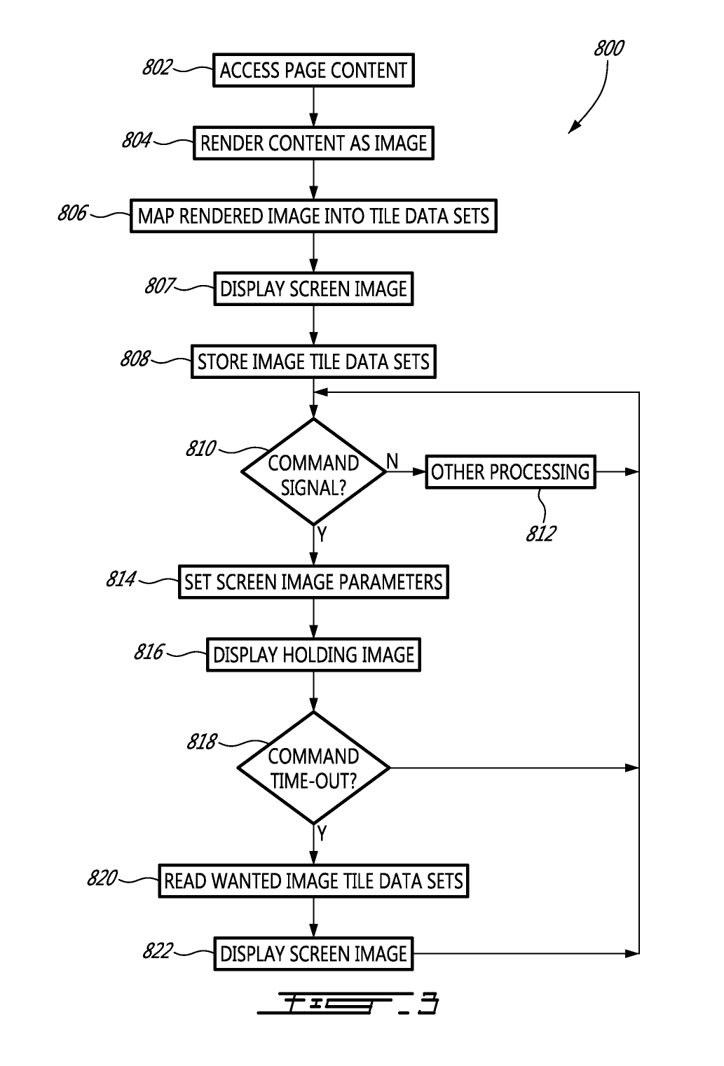

Internet or other interface screen content (herein also referred to as “page content”, or “web-page content’) sought to be accessed by a user of a handheld device configured for operation in accordance with the disclosure can comprise image, video, text, hypertext, and/or other content which, if displayed in its intended entirety and intended configuration, could correspond to content which can be schematically illustrated as being of a virtual scaled geometric and/or data size corresponding to interface screen content region 400 of FIGS. 1 and 2. Such content is typically conceived (and/or designed), and formatted, as optimized for viewing on a relatively large screen such as a standard desktop computer display screen. Such intended complete interface screen content 400 is typically significantly larger than the screen content 500 which can be practicably displayed for effective human interpretation on a smaller screen such as screen 200 of a handheld device 100.

Content is practicably displayed on a screen 200 when it is suitable for its intended purposes, including for example being effectively read or otherwise interpreted by a human being, and interacted with using, for example, one or more of input command devices 404.

Page or other interface screen content data 400 can include any type of displayable computer content, including for example static and/or video images, and/or active or non-interactive text such as virtual print and/or hyptertext links. Such content may include content that is preferably displayed synchronously (e.g., video content) and content that may be displayed asynchronously (e.g., static content).

FIG. 2 provides a comparative conceptual diagram of a relative capacity of a backingstore display memory, display size of a page or web content virtual image 400, and size of an effective handheld or other content display 500, 550. As suggested by FIG. 2, handheld or other computer device 100 operated in accordance with an example embodiment can comprise backingstore memory 700 of a relative size which may be larger than, smaller than, or the same as that required for storing the entire display content 400. Typically, the backingstore memory 700 may be smaller than the size required for storing the entire display content 400. As such, typically only a portion of the display content 400 is rendered and stored in the backingstore memory 700. The backingstore 700 may serve as a cache of pre-rendered content that allows the displayed data 550 to be updated relatively quickly, without the time lag required for rendering content. Content in the backingstore 700 may be pre-rendered in-between other processes, as will be described further below.

In the example shown in FIG. 2, the data size or intended display size of the display content 400, exceeds the effective display capacity of display screen 500, 550. Thus it is not generally possible for the entire page content 400 to be displayed on screen 200 in an intelligible or otherwise practicable format to fit the displayable size 500, 550.

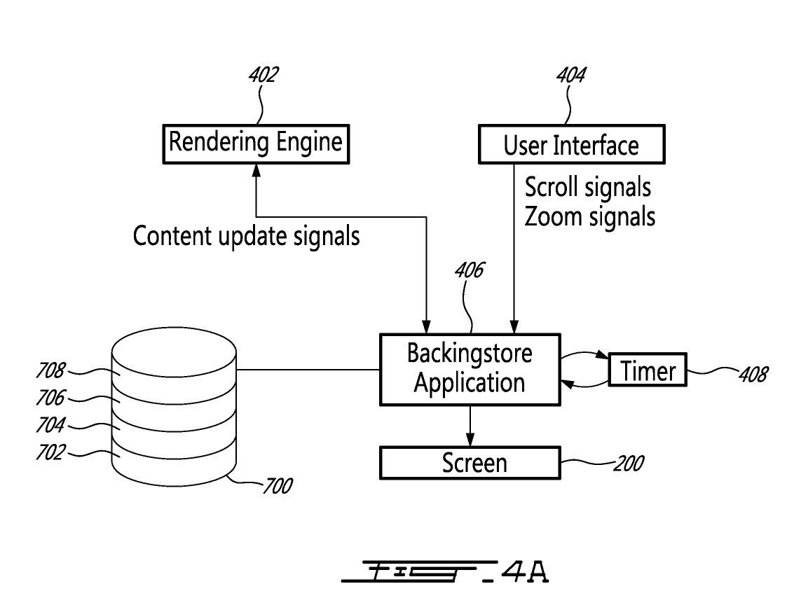

FIG. 3 is a schematic flow chart of an embodiment of a process or method of displaying page or other display content on a computer screen in accordance with the disclosure herein. Process 800 of FIG. 3 is suitable for implementation in an environment and using systems such as, for example, those shown in FIGS. 1, 2, 5 and 6. For example, process 800 may be suitable for implementation by a display controller of handheld computer 100 adapted for controlling screen 200.

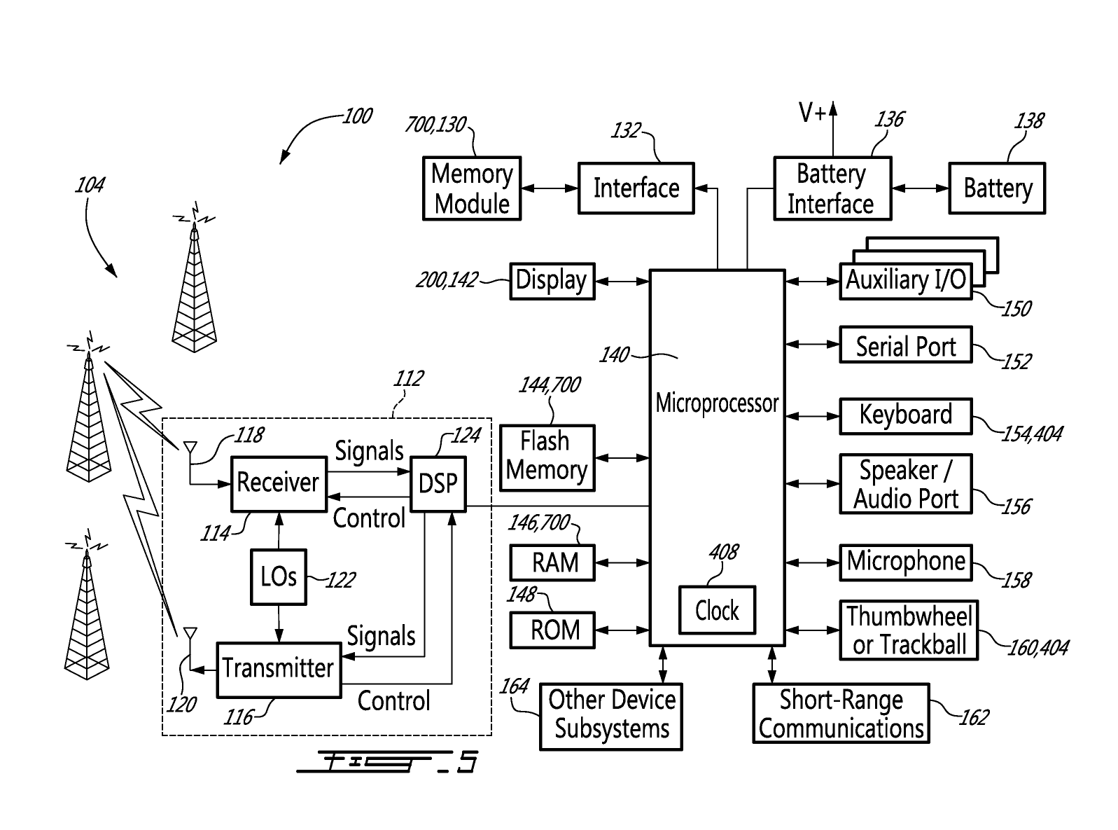

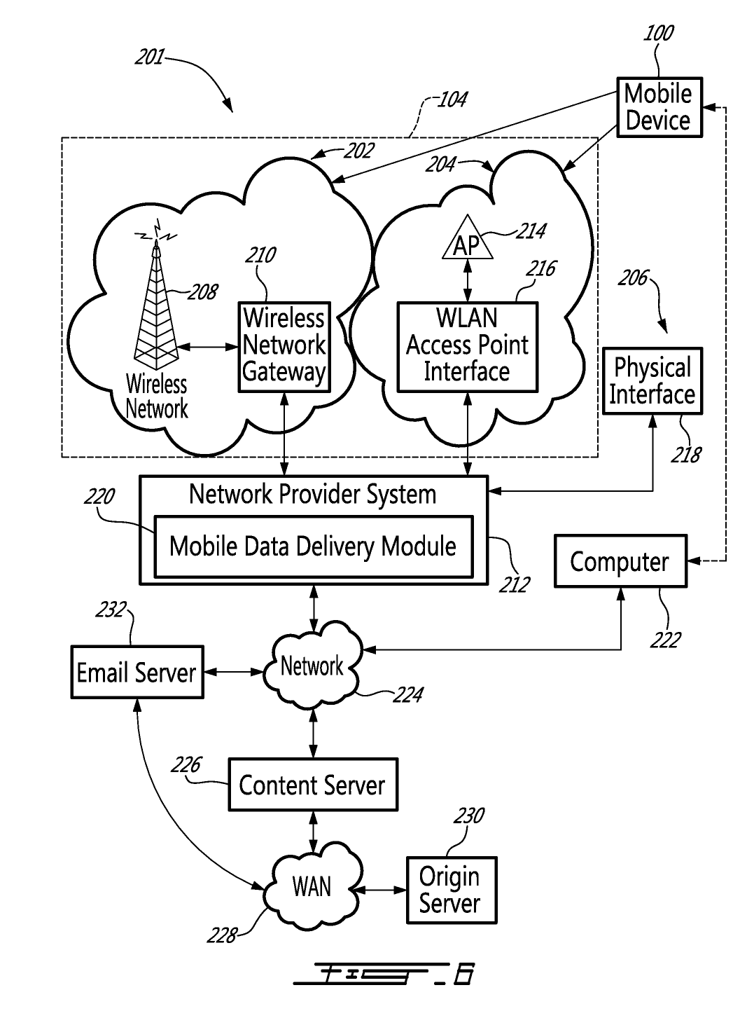

A user of a handheld device 100 desiring to view image or other display content 400, such as a web page, can provide the handheld or other computer's processor 140 (FIG. 6) with suitably-configured command inputs using, for example, a keyboard or other user input device 404. The resulting input command(s) may be received by the processor 140 which, at 802, can cause the processor to access the desired display content 400 (e.g., a remotely-stored web page) using, for example, suitably-configured read commands adapted for accessing remote servers and/or databases 226, 230, 232, 222 (FIG. 6) across a network such as the Internet, and/or on-board memory(ies) 130, 144, 146, 148 (FIG. 5). The display content 400 is typically received at the processor 140 as coded instructions for rendering an image (e.g., an HTML-coded content for displaying a webpage content). The coded instructions for the entire display content 400 may be received and stored in the memory 144, 146, 148, 130 (FIG. 5) and the coded instructions may be further converted into formats (e.g., an HTML-coded content data set, may be converted into a Document Object Model (DOM) tree and/or a WebKit tree). Due to the inherent limitations of the handheld or other computer display device, including for example the limited physical size of handheld computer display screen 200 and its buffer(s) or other memory(ies) (which can store, for example, data useful in presenting handheld screen image data 550) the display content 400 is often larger than the maximum size intended for display on the screen 200, and in any event is often larger than may be intelligibly displayed as a single, unbroken image on the screen 200.

At 804 the display content 400 is mapped into one or more content tile data sets 505. This mapping may involve dividing the content 400 into a plurality of defined tiles 505 that together make up the entire display content 400. The tiles 505 may be defined to represent relatively small and manageable portions of the page image content rendered at 804, as shown at 510 in FIG. 2. Although the display content 400 may be defined into content tile data sets 505, the content tiles 505 only define areas for rendering and are not necessarily rendered until required, as described further below.

For example, display content 400 can be divided into images of fixed width W and height H (defined for example in pixels or units of linear measurement), as shown in FIG. 2. H and W may be of the same or different dimension for any given tile, and may be constant or variable from one tile or set of tiles to another. The dimensions of the tiles may be defined to be smaller than, larger than or equal to the size of the screen 200. The actual size(s) of tiles 505 can configurable, and can be optimized for best performance on various devices and use with various applications. Although shown as relatively rectangular, the tiles 505 may be any suitable regular or irregular shapes that complement each other to form the content 400. For example, the tiles 505 may be interlocking shapes, squares, rectangular, hexagonal, etc. The tiles 505 may also be differently sized.

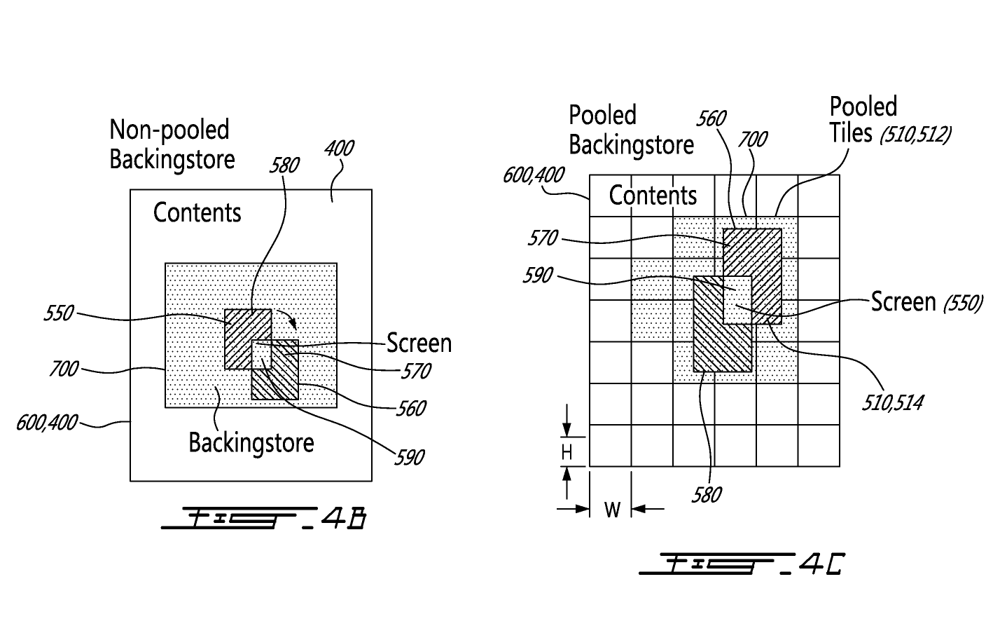

At 806, rendered tiled image data sets 510 to be rendered and stored in the backingstore 700 are rendered into image format, using, for example, a tool such as WebKit™ or any other suitably-configured web browser algorithms and/or programming product. For example, the tiled image data sets 510, or any portion thereof, can be rendered as a bitmap or other image, regardless of the source or type of content received and the process(es) by which such content is intended by its providers to be displayed. For example, any or all content provided in the form of a hypertext markup language (HTML) document, with mixed text, hypertext, and image content can be virtually assembled and rendered into a form of data processible by the display processor(s) of the display device as image content. The tiled image data sets 510 to be rendered and stored in the backingstore 700 may be defined based on the content to be displayed on the screen 200, as will be described further below. Thus, rather than working with a single, relatively large image, a plurality of tiled image data sets 510 to be placed in the backingstore 700 can be used. When the rendering engine (see FIG. 4) is instructed to write/draw a portion of the display content 400 to the backingstore 700, it can be assigned one or more specific tiled image data sets 510 to render. The backingstore 700 may store a portion of the display content 400 as multiple tiled image data sets 510, rather than as a single rendered image. This may allow for more efficient allocation of memory, since the tiled image data sets 510 do not necessarily occupy adjacent blocks of memory, and may allow for more efficient rendering of the content stored in the backingstore 700, since the tiled image data sets 510 may be rendered individually, rather than rendering the entire backingstore 700 altogether.

Each tiled image data set 510 may include position data and image data. The position data and image data associated with each tiled image data set 510 may be stored together in the memory 144, 146, 148, 130 (e.g., as individual data records comprising multiple header and content data fields), or may be stored separately (e.g., referenced and/or cross-referenced using pointers and/or indices). Position data associated with such a data set may include information about the logical relative position of the portion of the display content 400 and/or the tiled content data set 505 that is represented by the rendered tiled image data set 510. For example, the position data may include a coordinate location (e.g., pixel location) of the tiled content data set 505 corresponding to the tiled image data set 510. The position data may be stored as a header for the tiled image data set 510, or as a portion thereof. Associated image data may include rendered image data, for example, a bitmap of the corresponding tiled content data set 505. The tiled image data set 510 may further include one or more indicators, such as one or more flags, indicating whether the image data is committed (i.e., no update required) or uncommitted (i.e., update required). A tiled image data set 510 may also include shift data that indicates a new indicated and/or requested logical location (e.g., number of shifted pixels or tiles relative to the current logical location) of the new tiled content data set 505 that is to be rendered to update the image data. An example of a tiled image data set 510 can comprise the following information:

<position data><x-coordinate location><y-coordinate location>

<committed flag>

<shift data><tiles shift right><tiles shift down>

<image data><rendered bitmap pixels>

### Where:

<position data> indicates that the following records indicate the relative intended location of the image tile in the complete image data content 400
<x-coordinate location> indicates a current horizontal (i.e., left-right) indicated desired location of the image tile relative to the portion of the image data currently displayed
<y-coordinate location> indicates a current vertical (i.e., up-down) indicated desired location of the image tile relative to the portion of the image data currently displayed
<committed flag> indicates whether the associated image tile is in a state committed for rendering as a displayable (e.g., bitmap) image
<shift data> indicates that the following records provide information relating to pending navigation requests entered by a user of an input device 404
<tiles shift right> indicates a command to shift tiles right (or left) (i.e., scroll) by, for example, an input or otherwise detected number of pixel columns
<tiles shift down> indicates a command to shift tiles downward (or upward) (i.e., scroll) by, for example, an input or otherwise detected number of pixel rows
<image data> indicates that the following records comprise bitmap or otherwise-formatted image data for processing and display
<rendered bitmap pixels> comprises bitmap or otherwise-formatted image data for processing and display

At 807 image tile data sets 510 can be stored in the backingstore memory 700 of the device 100. As described above, the image tile data sets 510 may or may not be stored in adjacent blocks in the memory 144, 146, 148, 130.

At 808 a first portion 550 of the display content 400 can be displayed on screen 200. Displayed portion 550 can be constructed using at least a portion of one or more rendered image tile data sets 510, 511 retrieved from the backingstore 700. It should be understood that in some examples the steps of the process 800 may occur in different orders. As a particular example, step 808 may occur before 807.

At 810 the display control processor (e.g., 140) of the handheld device 100 can determine whether any as-yet-unexecuted image control commands have been received from user input devices associated with the handheld device 100. For example, the display control processor can determine whether a user has activated a trackball 160, “arrow key,” or other navigation device 404 in order to view currently undisplayed content, so that, for example, corresponding display control commands are waiting in a display control buffer or other memory.

If at 810 no unexecuted image control commands are determined to be awaiting execution, at 812 the processor(s) of handheld device 100 can proceed with any other pending processing, such as loading any incomplete data sets (including loading and/or rendering of image tiles to replace holding data, as described herein), storing data held in execution or display buffers, updating backingstore data, executing commands for unrelated applications, etc.

If at 810 a newly-received or otherwise unexecuted image control command is determined to be waiting for execution, at 814 such command can be interpreted and processed to set any indicated or otherwise suitable or desired screen image parameters. For example, a scrolling command comprising parameters useable in defining or otherwise describing previously-undisplayed portions of display content 400 and relative boundaries, scaling, etc., for an adjacent or otherwise desired or newly-selected portion 500, 560 of image content 400 can be read.

If at 810 an image control command is read or otherwise processed, at 814 new screen image display parameters can be set, for modifying displayed content 500, 550 (e.g, displaying an adjacent or otherwise previously-undisplayed portion 560 of the content 400 in response to a scrolling image control command), and corresponding image tile data sets 510 can be accessed from the backingstore memory 700. This may require copying display data from the backingstore 700, from currently displayed tiled image data sets 511 and/or currently not displayed tiled image data sets 510. This may also require new data to be rendered from tiled content data sets 505 into new tiled image data sets 513 and stored in the backingstore 700.

At 816 any or all portions of currently-displayed image tiles 510, 511 can be deleted from the displayed screen image 550 and, as appropriate, redisplayed in new location(s) on the screen 200, to form a requested new display image 560. Any rendered screen image tile data set(s) 510 not corresponding to previously-displayed image 550 can be retrieved from the backingstore 700. Any display data corresponding to not yet rendered new tiled image data sets 513 can initially be displayed using placeholder image data, such as a checkerboard, grey-out, or other pattern requiring relatively little processing to display.

Optionally, at 818 it can be determined whether a predetermined time (such as 1 or more seconds, or any portion(s) thereof) has elapsed between entry of image control input commands. If the predetermined time has not elapsed, then process 800 may return to 810 to determine if there are any other image control input commands to be processed. For example, if a user is rapidly scrolling the displayable window 500 through continuing portions of the display content 400, the processor may loop back to 810 prior to accessing and displaying further image data, in order to reduce processing time and effort.

If at 818 a predetermined time has elapsed, at 820 the display controller can read, from the backingstore memory 700, image content data corresponding to previously-undisplayed image data tiles 510 that are to be displayed in the new screen content 560, and at 822 such data can be written to the display buffer for painting on the display screen 200. Where new tiled image data sets 513 to be displayed are not yet rendered, rendering of new tiled image data sets 513 may take place asynchronously (e.g., in between other processes) and uploaded into the backingstore 700. Uploading new tiled image data sets 513 may require one or more currently stored tiled image data sets 510 to be erased from the backingstore 700.

The backingstore 700 may also be updated with new tiled image data sets 513 containing rendered image data that are not required to be displayed, but which may be expected to be required for display, for example based on a predicted navigation of the content 400. The prediction of the new tiled image data sets 513 to be rendered and the currently stored tiled image data sets 510 to be erased from the backingstore 700 may be based on a prediction algorithm.

If at 816 placeholding data has been displayed in regions of the screen 200 in which newly-displayed content is to be placed, the holding image data can be replaced with the new content 513.

Once a new screen image 560 has been displayed, control can return to 810 and the event loop 810, 822 can be repeated indefinitely, as for example until an application causing display of the page content 400 is ended.

Thus process 800, and in particular event loop 810-822, can be executed in discreet serial steps which are interleaved with processing of other programs, or of other portions of a same program (i.e., pseudo-asynchronously, or in other parallel processing schemes).

Data read from a backingstore 700 into a display buffer for painting to the screen 200 may be sorted, stored, and otherwise processed such that tiled image data sets 510 intended to be displayed in closest proximity to the most recently displayed data sets are displayed first. As part of such a sorting process, tiled image data sets 510 may be stored sequentially in memory, for example in patterns corresponding to a relation in which they will be processed for displaying thus helping to ensure that the display will only be requested to display sets of display tiles of relatively small size and aligned along a grid, or otherwise efficiently processible. Such data may be stored sequentially through, for example, the use of suitably-adapted address headers, which may be read and processed rapidly by a display processor. Such headers may be sequentially ordered in, for example, numeric or alphanumeric order corresponding to a pattern or plan according to which the data may be rapidly accessed and displayed. In other examples, the tiled image data sets 510 may be stored in any arbitrary location in memory

Thus the present disclosure provides software-based alternatives to hardware-assisted backingstore memory, making use of any of a wide variety of existing memory(ies) 700 (e.g., any or all of memory(ies) 144, 146, 130 of FIG. 5) to display various portions 550 of content data 400 in intelligible format on a screen 200. In particular, in some aspects, there is provided a pseudo-asynchronous tiled backingstore for use devices in which the use of custom or special-purpose hardware is not desirable. The present disclosure provides processes, and systems, methods, devices, and programming structures for implementing them, for the display of image and other page content that may be asynchronously executed, without blocking down or substantially delaying execution of other processes, such as the continued manipulation of display controls by a user (e.g., continued scrolling) or execution of other functions by a processor controlling the display function(s). Thus such display process may be executed, in accordance with an example embodiment, in parallel with other processes instead of serially, so that processes executed in parallel are not unduly delayed.

FIGS. 4A-4C provide schematic illustrations of examples of aspects of the present disclosure.

FIG. 4A is a block diagram illustrating an example of signal flow in accordance with aspects of the present disclosure. As shown, one or more user input devices 404, such as one or more thumbwheels, trackballs, touchpads and/or keyboards, can provide display control command signals, such as scroll or magnify (zoom) commands, etc., to a backingstore application 406 executed by one or more processors 140 of, for example, a device 100 (FIG. 5). The backingstore application 406 interacts with a content rendering engine (or application) 402, which may be executed by the same or other processor(s), and backingstore memory(ies) 700 to render image content for storing in the backingstore memory(ies) 700 and for display of data on a display 200. The backingstore application 406 further interacts with a timer 408 which can, for example, monitor elapsed time(s) between receipt of display control signals from the user input device(s) 404.

In response to one or more zoom, scroll, or other display control command signals provided by a user input device 404, backingstore application 406 can cause new display content to be displayed on the display 200. Optionally, such content can comprise actual requested image content 400 from backingstore 700, and/or placeholder data such as a gray, checked or other relatively-easily rendered “background” effect, which can be processed and displayed relatively more quickly, and with less expenditure or processing resources, than actual intended display content. If, for example, as at 818 display control signals are, as determined using timer 408, received from the user input device 404 faster than a predetermined display holding time, i.e., an actual amount of time necessary for rendering and display of actual intended content, or a predetermined threshold time which may be representative of such time, then backingstore application 406 can cause such placeholder content to continue to be displayed on the screen 200 in lieu of actual intended content, pending receipt of further display control signals. If, as determined using timer 408, more than such actual or threshold time has elapsed since receipt of the last display content signal(s) from user input device(s) 404, backingstore application 406 can cause rendering engine 402 to provide actual intended content for display on the display 200.

In an example embodiment, the backingstore application 406 may implement a non-pooled backingstore scheme in which, for example, image tile data sets 510 correspond to image content having a static predefined logical relationship, such as an ordered array or grid of tiled content data sets 505 (e.g., a defined rectangle of content 400 or any other predefined shape), for example as shown in FIG. 4B. In another example embodiment, the backingstore application 406 may implement a pooled backingstore scheme, in which, for example, image tile data sets 510 correspond to image content have a dynamically defined logical relationship, which may be a set tiled content data sets 505 in any arbitrary arrangement (e.g., a rectangular region, an L-shaped region, non-adjacent regions or any irregularly-shaped region of content 400) that may be dynamically changed, for example as shown in FIG. 4C.

In implementing processes for displaying content data on, for example, a screen 200, a data processor (e.g., microprocessor 140 of FIG. 5) can perform the following steps:
a) When, during the process of rendering an image for display, display content command signals are received, which signals signify that requested display content 550 affecting one or more areas of display 200 has changed, and that such content is to be updated immediately:
   i) backingstore application 406 is caused to designate previously undisplayed (“new”) portion(s) 570 of content as requested data, and, to the extent actual requested display content 560 is not already pre-rendered and stored in the backingstore 700, from which display is immediately possible, are flagged as “dirty” regions and assigned to a dirty tile queue (a queue of unrendered tiled content data sets 505, whose image content is to be substituted temporarily by holding image data until such time as the corresponding image content is rendered).
   The requested display content 550 may also include “critical” portion(s) (also referred to as critical regions), may be those that are to be used for synchronously updating the screen 200. The “dirty” portion(s) of content (also referred to as dirty regions) may be regions of the screen 200 that are to be updated but will be temporarily represented on the screen 200 with placeholder data (e.g., where the corresponding image content has not yet been rendered). Critical regions may be associated with content that is to be rendered synchronously (e.g., animation or video) and therefore is accorded a higher priority for rendering. Critical regions may correspond to image content for tiled image data sets 513 that are not yet stored in the backingstore 700, or may correspond to image content for tiled image data sets 510 that are stored in the backingstore 700 but that requires refreshing. In some examples, critical regions, being accorded higher priority, should not or only very rarely be queued in the dirty queue. The dirty regions may be associated with content that may be rendered asynchronously, such as when the application is not busy and hence may be accorded lower priority for rendering and may be queued in the dirty queue. In some examples, all of the content may be considered dirty (e.g., when the content is navigated very quickly, entirely outside the area corresponding to the pre-rendered tiled image data sets 510), such that all regions may be temporarily represented with placeholder data;
   ii) step f) below (“Update backingstore 700 and any display buffer(s)”) is performed; and
   iii) relevant areas of screen 200 are updated by deleting unwanted content 580 and diplaying requested new (or placeholder) content 560, and particularly previously undisplayed content 570, as available.
b) When signals are received signifying that content has changed in an area of the screen 200 and that the content does not need to be updated immediately (e.g., where the region is associated with content that may be rendered asynchronously):
   i) the area is assigned to the “dirty” tile queue, for temporary filling by placeholder data, pending availability of requested image data; and
   ii) backingstore update timer 408 is started, if not already active (cf. block 818 in FIG. 3).
c) When a user input device 404 provides signals signifying a command to scroll displayed content 550:
   i) the area of the content 400 to be pre-rendered and stored in the backingstore 700 (e.g., based on parameters defining requested content 560) is/are adjusted, if necessary;
   ii) dirty areas are identified (i.e., any new portions of the content 400 that need to be rendered into tiled image data sets 510), and assigned to the dirty region queue, if not already assigned;
   iii) dirty areas required for display on the screen 200 are displayed using placeholder image data, if not already so displayed;
   iv) non-dirty critical regions are updated by display of requested content 560, 570, as appropriate; and
   v) backingstore update timer 408 is started, if not already active.
d) When user input device 404 provides signals signifying a request for zooming of the page:
   i) all the tiled image data sets 510 must be re-rendered to account for the zoom transform and hence the full backingstore 700 is added to the “dirty” tile set;
   ii) a new display content data set 560 is determined (including accessing any original display content source(s) 226, 230, 232, 222, 130, 144, 146, 148 as needed, taking into account a new zoom transform useful for rendering image data comprised by one or more tiled content data sets into one or more new, magnified or zoomed, tiled image data sets. The tiled content data set 505 may also be redefined based on the zoom transform. Such a transform can, for example, comprise data representing a requested zoom scaling factor and/or a requested region content to be displayed in the zoomed content. During this rebuilding, the currently displayed content is considered the critical region (i.e., accorded higher priority) and all other image content to be rendered for the backingstore 700 is considered the dirty region (i.e., accorded lower priority);
   iii) relevant display areas (e.g., the areas that are to be zoomed or magnified) are updated as necessary (e.g., by applying the necessary transform to the content and rendering the tiles accordingly); and
   iv) backingstore update timer 408 is started, if not already active.
e) When the backing store update timer 408 fires, i.e., when according to timer 408 a display holding time (an actual amount of time necessary for rendering and display of actual intended content, or a predetermined threshold time which may be representative of such time) has expired:
   i) timer 408 is stopped;
   ii) step f) (“Update backingstore 700 and any display buffer(s)”) is performed; and
   iii) relevant display areas are updated as necessary.
f) Update backingstore 700 and any display buffer(s):
   i) as many dirty areas are updated (i.e., rendered and stored in the backingstore 700) as time allows before new display control signals are provided by user input device 404; and
   ii) if unrendered dirty areas remain, they are retained in the dirty region queue, and backingstore update timer 408 is started, if not already active.
g) When the backingstore application 406 is idle (i.e., when no display control signals have been received from user input device 404 for at least the display holding time:
   i) backingstore update timer 408 is started, if not already active.

In the foregoing example embodiments data may be “tiled,” in the sense that the display content 400 is mapped to a set of discreet areas (i.e., the tiled content data set 505), the matrix of which forms the content data set to be displayed, e.g, a web page or other virtual page. A difference between the pooled and non-pooled embodiments occurs in step ‘c)’ of the program flow.

In a ‘non-pooled’ embodiment (e.g., as described with respect to FIG. 4B), the entire backingstore 700 is updated in memory when the backingstore 700 is updated, e.g., the content is scrolled to an area outside the content pre-rendered in the backingstore 700 or the content zoomed. For example, the content data stored in the backingstore memory 700 may be updated to contain new tiled image data sets 510 centered on the portion 550 displayed on the device 200. Typically, in the non-pooled embodiment, the tiled image data sets 510 correspond to image content having a static predefined logical relationship with each other, for example the tiled image data sets 510 may correspond to image content in a predefined sequence of content (e.g., in a rectangular or square shape). Thus, for any given scrolling navigation, the tiled image data sets 510 are updated according to the predefined logical relationship of the content, even where such predefined content arrangement may not be optimized for the navigation. For example, where navigation is only in a vertical direction, the tiled image data sets 510, e.g., being preset to render content in a square shape, may nonetheless be updated to include image content in horizontally-adjacent areas that have a low likelihood of being displayed.

In a ‘pooled’ embodiment (e.g., as described with respect to FIG. 4C), instead of updating the entire backingstore 700 to shift with and virtually center upon the currently-displayed portion 550 of the content, the backingstore application 406 may adjust the tiled image data sets 510 to correspond to image content having a dynamic logical relationship to each other. That is, the tiled image data sets 510 may correspond to content in an arrangement that may be dynamically changed to any arbitrary shape (e.g., rectangular, square, L-shaped, irregularly-shaped, non-adjacent content areas), based on predicted display requirements (e.g., based on a prediction of expected navigation input). The adjusting of tiled image data sets 510 may be based on a prediction of the image content that will be requested for display. For example, the tiled image data sets 510 may be adjusted by erasing from the backingstore memory 700 the row or column of tiles that are furthest from the newly revealed viewport, and updated to include new tiled image data sets 510 corresponding to image portions that are closer to the currently-displayed region 550, and therefore most likely to be required in building a new diplay 560 in response to user inputs. For example, where navigation is only in a vertical direction, the tiled image data sets 510 may be adjusted to correspond to content in a logical relationship showing to a vertical column of tiled content data sets 505, which may minimize the amount of stored image data that is unlikely to be displayed (in this example, horizontal image data). This logical relationship may be dynamically changed, for example to correspond to a horizontal row of tiled content data sets 505 when navigation changes to a horizontal direction. This pooled embodiment may be useful for increasing the efficiency of the backingstore 700 and decreasing the amount of data queued in the dirty queue (and hence decreasing the amount of time that the screen 200 would need to show a placeholder pattern).

In the pooled embodiment, the dynamic logical relationship for content to be rendered in the tiled image data sets 510 may be dynamically determined using a prediction algorithm.

For example, when an instruction to scroll the screen content 500 (e.g., down) is received (e.g., in response to input from an input device 404), it may be useful for the backingstore 700 to be updated with tiled image data sets 510 having content in a logical position that is in the direction of the scrolling (e.g., downwards) and to replace content in a logical position that is in the direction opposite to the scrolling (e.g., upwards). That is, the prediction algorithm may assume that the scrolling instruction will be maintained in the same direction, and thus the backingstore 700 can be updated with rendered as far in the direction of the scrolling as possible, while discarding as much as possible rendered content in the direction opposite to the scrolling, or at least releasing memory resources associated with such content for possible over-writing and reuse with refreshed data more likely to be wanted for display.

Since rendering of image content may be a time-consuming operation, completed in some instances in competition with other data processes which may have been deemed by processor(s) 140 as more critical, it may not be possible to completely update the backingstore 700 within an available time period (e.g., before a threshold monitored by update timer 408 expires, within the period of the frame refresh of the screen 200, or during processor idle times). Rather, tiled image data sets 510 that will be replaced may be flagged to be updated (e.g., by setting a committed flag to “FALSE” or other suitable value) and the relative shift of the logical position of the new content may be indicated in the shift data, which may be done using relatively little processing power and time, without updating the image data with new rendered content. That is, the logical relationship (e.g., logical position) for content to be rendered may be dynamically determined immediately or nearly immediately in response to input instructions, but rendering of the content may occur only at predetermined time intervals (e.g., only at expiration of the update timer 408).

For example, a given tiled image data set 510 may start with:

<position data><x-coordinate = 10><y-coordinate = 10>

<committed flag = TRUE>

<shift data><tiles shift right = 0><tiles shift down = 0>
<old image data>

When an instruction to scroll down is received and the given tiled image data set 510 is determined to be replaced, the given tiled data set 510 may be changed to:

<position data><x-coordinate = 10><y-coordinate = 10>

<committed flag = FALSE>

<shift data><tiles shift right = 0><tiles shift down = 10>
<old image data>

Notably, the tiled data set 510 may not yet contain any new or refreshed rendered content. During the period before new content is rendered (e.g., the update timer 408 has not yet expired or the processor does not have any idle time yet), additional scrolling instructions may be received, which may be additional scrolling in the same or different directions, and the shift data of the tiled data sets 510 may be changed accordingly, again without updating the image data:

<position data><x-coordinate = 10><y-coordinate = 10>

<committed flag = FALSE>

<shift data><tiles shift right = 10><tiles shift down =

20>

<old image data>

When the update timer expires 408, the image data of the tiled data sets 510 may be rendered, for example in the order of the dirty tile queue. When a given tiled data set 510 has its image data updated, with tiled content according to the logical position indicated by the shift data, the committed flag is reset to TRUE and the shift data is reset to zero:

<position data><x-coordinate = 20><y-coordinate = 30>

<committed flag = TRUE>

<shift data><tiles shift right = 0><tiles shift down = 0>
<new image data>

In some cases, scrolling instructions may return the screen content 500 to, or close to, the starting position (i.e., the position of the last fully-rendered, fully diplayed processing request prior to receipt of a navigation command) before the update timer 408 has expired. In such situations, the shift data of the tiled data sets 510 may reflect that the shift is zero, and relevant image data may remain in the backingstore 700 without having been overwritten. When the backingstore application 406 detects that the shift data of a given tiled image data set 510 indicates a shift of zero, for example, then it may be determined that the image data of the given tiled image data set 510 does not require any update, and the committed flag can be (re)set to TRUE. Thus, the image data of the given tiled image data set 510 may be maintained and unnecessary rendering and/or other processing may be avoided.

Thus, in some examples, for the pooled embodiment, the image tiles 510 in the backingstore 700 may be progressively shifted as scrolling of the displayed content takes place, such that new, undisplayed, image tiles 510, 513 are progressively rendered and stored already in the backingstore 700 as scrolling continues in the same direction. In some examples, a new image tile 510 may not be rendered with new content (i.e., may remain uncommitted) until a certain time threshold is met (e.g., based on the display holding time according to the timer 408). This may allow prevent erasure of current image tiles 510 (i.e., the current image tile 510 maintains the content prior to any scrolling) and rendering of new content data until the very last moment (e.g., until the expiry of the update timer 408), which may avoid unnecessary processing, for example where the scrolling quickly changes direction. For example, if the content is scrolled down very fast, then the image tiles 510 are progressively updated with image content downwards. If the scrolling then suddenly changes to upwards very fast before the time threshold is met, the current image tiles 510 have not yet been replaced with new image tiles 510 for downard content and retain the content prior to the scrolling, so that no new rendering is necessary.

Although the above prediction algorithm has been described with reference to scrolling instructions, it should be understood that a similar algorithm may apply to zooming instructions. For example, multiple zooming instructions may be received prior to expiration of the update timer 408, and rendering of new content for the tiled image data sets 510 may accordingly be postponed until expiration of the update timer 408, such that any unnecessary rendering is avoided. For example, instructions to zoom in may be quickly followed by instructions to back zoom out to the original magnification, before expiration of the update timer 408, such that the tiled image data sets 510 still retain the original image data and no new rendering is necessary.

It is to be noted also that a wide variety of other prediction algorithms are possible, and may be used in implementing the various aspects of the invention.

Reference is now made to FIG. 5, which shows a block diagram illustrating an example of a device 100 suitable for implementing the present disclosure. In the embodiment shown, device 100 is a wireless handheld communications device. It will be understood that references to such or other handheld computer devices in this disclosure may refer to wireless devices, handheld devices, mobile devices, small screen devices, and/or other similar devices.

In the embodiment shown, handheld computer device 100 may communicate through a wireless communication network 104 with severs and/or other remote sources 224, 226, 230 of content to be displayed in accordance with the disclosure herein. The wireless network 104 may include antennae, base stations, and supporting radio equipment as for supporting wireless communications between the handheld computer device 100 and other devices connected to wireless network 104. The wireless network 104 may be coupled to a wireless network gateway and to a wide area network, shown in FIG. 6.

In various embodiments, a handheld computer device 100 may be a two-way mobile communication device having at least voice and data communication capabilities, including the capability to communicate with other computer systems. Depending on the functionality provided by a handheld computer device 100, it may for example be referred to as a data messaging device, a two-way pager, a cellular telephone with data messaging capabilities, a wireless Internet appliance, or a data communication device (with or without telephony capabilities). A handheld computer device 100 may communicate with any one of a plurality of fixed transceiver stations within its geographic coverage area.

A handheld computer device 100 may incorporate a communication subsystem 112 which includes a receiver 114, a transmitter 116, and associated components, such as one or more antenna elements 118 and 120, local oscillators (LOs) 122, and a processing module such as a digital signal processor (DSP) 124 for processing communications signals which may, for example, include signals representing content to be displayed on the device 100. In various embodiments, antenna elements 118 and 120 may be embedded or internal to the handheld computer device 100. As will be apparent to those skilled in the field of communications, the particular design of the communication subsystem 112 may depend on the wireless network 104 in which the handheld computer device 100 is intended to operate.

Such a handheld computer device 100 may send and receive communication signals, including content data signals for display on the device 100, over the wireless network 104 after the required network registration or activation procedures have been completed. Signals received by the antenna 118 through the wireless network 104 may be input to the receiver 114, which may perform such common receiver functions as signal amplification, frequency down conversion, filtering, channel selection, etc., as well as analog-to-digital (ND) conversion. ND conversion of a received signal may allow more complex communication functions such as demodulation and decoding to be performed in the DSP 124. In a similar manner, signals to be transmitted may be processed, including modulation and encoding, for example, by the DSP 124. These DSP-processed signals may be input to the transmitter 116 for digital-to-analog (D/A) conversion, frequency up conversion, filtering, amplification, and transmission to the wireless network 104 via the antenna 120. The DSP 124 may not only process communication signals, but may also provide for receiver and transmitter control. For example, the gains applied to communication signals in the receiver 114 and the transmitter 116 may be adaptively controlled through automatic gain control algorithms implemented in the DSP 124.

Network access may be associated with a subscriber or user of the handheld computer device 100 via a memory module, such as a memory module 130, which may be a Subscriber Identity Module (SIM) card for use in a GSM network or a Universal Subscriber Identity Module (USIM) card for use in a Universal Mobile Telecommunication System (UMTS). The SIM card may be inserted in or connected to an interface 132 of the handheld computer device 100 in order to operate in conjunction with the wireless network 104. Alternatively, the handheld computer device 100 may have an integrated identity module for use with systems such as Code Division Multiple Access (CDMA) systems.

A handheld computer device 100 may also include a battery interface 136 for receiving one or more rechargeable batteries 138. The battery 138 may provide electrical power to at least some of the electrical circuitry in the handheld computer device 100, and the battery interface 136 may provide a mechanical and electrical connection for the battery 138. The battery interface 136 may be coupled to a regulator (not shown) which may provide power V+ to the circuitry of the handheld computer device 100.

The handheld computer device 100 may include one or more microprocessors 140 which may control the overall operation of the handheld computer device 100, in addition to image and display processing functions such as backingstore and other display operations, as disclosed herein.

Communication functions, including at least image and other data and voice communications, may be controlled by microprocessor(s) 140 through the communication subsystem 112. Microprocessor(s) 140 may also interact with additional device subsystems such as one or more of each of a display 200, 142, flash memory 144, a random access memory (RAM) 146, a read-only memory (ROM) 148, auxiliary input/output (I/O) subsystems 150, a data port such as serial port 152, one or more keyboards or keypads 154, 404, a speaker or audio port 156 for connecting to, for example a set of headphones or an earpiece, a microphone 158, a clickable thumbwheel or trackball 160, 404, and/or other user input device 404, a short-range communications subsystem 162, and any other device subsystems generally designated as 164.

Some of the subsystems shown in FIG. 5 may perform communication-related functions, whereas other subsystems may provide “resident” or on-device functions. Any or all of such functions may comprise content scrolling, zooming, or other navigation functions such as those described herein. Notably, some subsystems, such as keypad(s) 154, 404; display(s) 142, 200, and the thumbwheel(s)/trackball(s) 160, 404, for example, may be used for any or all of communication-related functions, such as displaying notifications or entering a text message for transmission over the wireless network 104; executing device-resident functions such as a clock, a calculator or a task list; and/or other navigating and virtual document processing, such as viewing, scrolling, and/or zooming display content such as a web page 400. Operating system software used by microprocessor(s) 140 may be stored in a persistent store such as the flash memory 144, which may alternatively be the ROM 148 or similar storage element. Those skilled in the art will appreciate that the operating system, specific device applications, or parts thereof, may be temporarily loaded into a volatile store such as the RAM 146. It should be understood that the backingstore memory 700 may be implemented in any one or more of the flash memory 144, the RAM 146 and the ROM 148, or any other similar storage element.

Microprocessor(s) 140, in addition to their operating system functions, may execute software applications, such as backingstore application 406, on the handheld computer device 100. A predetermined set of applications that control basic device operations, including data and voice communication applications, may normally be installed on the handheld computer device 100 during or after manufacture. The handheld computer device 100 may include a personal information manager (PIM) application having the ability to organize and manage data items relating to a user such as, but not limited to, instant messaging, email, calendar events, voice mails, appointments, and task items. One or more memory stores may be available on the handheld computer device 100 to facilitate storage of information, such as the flash memory 144, the RAM 146, the ROM 148, the memory module 130, or other types of memory storage devices or FLASH memory cards represented by the other device subsystems 164, such as Secure Digital (SD) cards or mini SD cards, etc.

The PIM and/or media applications may have the ability to send and receive data items via either or both of the wireless network 104 and a link to a computer system. The link to the computer system may be via the serial port 152 or the short-range communications subsystem 162. In an embodiment, PIM and/or media data items may be seamlessly combined, synchronized, and updated via the wireless network 104, with the wireless device user's corresponding data items stored and/or associated with a host computer system thereby creating a mirrored or partially mirrored host computer on the handheld computer device 100 with respect to such items. This may be useful where the host computer system is the wireless device user's office computer system. Additional applications may also be loaded onto the handheld computer device 100 through the wireless network 104, the auxiliary I/O subsystem 150, the serial port 152, the short-range communications subsystem 162, or any other suitable subsystem 164, and installed by a user in the RAM 146 or a non-volatile store such as the ROM 148 for execution by the microprocessor 140. Such flexibility in application installation may increase the functionality of the handheld computer device 100 and may provide enhanced on-device functions, communication-related functions, or both. For example, secure communication applications may enable electronic commerce functions and other such financial transactions to be performed using the handheld computer device 100. Any such applications may be executed in conjunction with backingstored content display techniques such as those described herein.

In data communication and processing modes, one or more received data signals representing information such as downloaded or otherwise-accessed web content 400, text messages, an email message, a media file to be transferred, may be processed by the communication subsystem 112 and may be input to microprocessor(s) 140 for, for example, display on a display 142, 200. Microprocessor(s) 140 may further process such signal for output to the display 142, 200, using for example backingstore application 406, or alternatively to another auxiliary I/O device 150. A user of the handheld computer device 100 may also compose, navigate, or otherwise manipulate data items, such as email messages or display content 400, for example, using keypad(s) 154, 404 and/or thumbwheel(s)/trackball(s) 160, 404 in conjunction with the display 142, 200 and possibly the auxiliary I/O device 150. Keypad(s) 154, 404 may comprise any one or more complete alphanumeric keypad or telephone-type keypad, etc. Such composed items may be transmitted through the communication subsystem 112 over the wireless network 104 or via the short range communication subsystem 162.

Serial port(s) 152 may be normally implemented in a personal digital assistant (PDA) type communication device for which synchronization with a user's computer is a desirable, albeit optional, component. Serial port(s) 152 may enable a user to set preferences through an external device or software application and may extend the capabilities of the handheld computer device 100 by providing for information or software downloads to the handheld computer device 100 other than through the wireless network 104. The alternate download path may, for example, be used to load software or data files onto the handheld computer device 100 through a direct, reliable and trusted connection.

Reference is next made to FIG. 6, which shows a communication system 201 suitable for use with a handheld computer device 100 such as that shown, for example, in FIG. 5. A communication system 201 generally may include one or more wireless or other computer/communications devices 100 (only one of which is shown in FIG. 6) and at least one wireless network 104. Wireless network(s) 104 may include wireless Wide Area Network(s) (WAN(s)) 202, Wireless Local Area Network(s) (WLAN(s)) 204, and/or other interfaces 206 (which may not necessarily be wireless).

A wireless WAN 202 may be implemented as a packet-based cellular or mobile network that includes a number of base stations 208 (one of which is shown in FIG. 6) where each of the base stations 208 provides wireless Radio Frequency (RF) coverage to a corresponding area or cell. The wireless WAN 202 may be typically operated by a cellular network service provider that sells subscription packages to users of the wireless devices 100, which packages may provide for the transmission of data content 400 to such devices. The wireless WAN 202 may comprise a number of different types of networks, for example, Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network) or various other third generation networks such as EDGE (Enhanced Data rates for GSM Evolution), UMTS (Universal Mobile Telecommunications Systems), or Evolution-Data Optimized (EV-DO).

As shown in FIG. 6, a communications system 201 may also include a wireless network gateway 210 and one or more network provider systems 212. The wireless network gateway 210 may provide translation and routing services between the network provider system(s) 212 and the WAN 202, which may facilitate communication between the wireless devices 100 and other devices (not shown) connected, directly or indirectly, to the network provider system 212.

A WLAN 204 may comprise a network which in some examples conforms to IEEE 802.11 standards such as one or more of 802.11b, 802.11g, or 802.11n; however, other communications protocols may also be used for the WLAN 204. The WLAN 204 may include one or more wireless RF Access Points (AP) 214 (one of which is shown in FIG. 6) that collectively provide a WLAN coverage area. For the embodiment depicted in FIG. 6, the WLAN 204 may be operated by an enterprise (for example, a business or university in a building or campus type environment) and the access points 214 may be connected to an access point (AP) interface 216. The AP interface 216 may provide translation and routing services between the access points 214 and the network provider system 212 to facilitate communication between two or more of the wireless devices 100 and other devices (e.g., such as desktop computers) connected, directly or indirectly, to the network provider system 212. The AP interface 216 may be implemented using a computer, for example, a server running a suitable computer program or software.

According to various embodiments, other interfaces 206 may be implemented using physical interface(s) indicated by reference 218. Such physical interface(s) 218 may include an Ethernet, Universal Serial Bus (USB), Firewire, or infrared (IR) connection implemented to exchange information between the network provider system 212 and the handheld computer device 100.

Network provider system 212 may comprise a server or server modules or a number of servers or server modules which are typically located behind a firewall (not shown). The network provider system 212 may include a number of modules including a mobile data delivery module 220. Various modules running on the network provider system 212 may be implemented as a number of services running on a single server or as a number of interconnected servers each running a software program to implement the functionality of the respective module. The network provider system 212 may provide access for the wireless devices 100, through either the wireless WAN 202, the WLAN 204, or the other connection 206 to the devices connected, for example, through an enterprise network 224 (e.g., an intranet), to the network provider system 212. In an embodiment, the data delivery module 220 may be implemented on a computer, such as the network provider system 212.

Enterprise or other network 224 may comprise a local area network, an intranet, the Internet, a direct connection, and/or combinations thereof. An enterprise network 224 may comprise an intranet for a corporation or other type of organization. In at least some embodiments, the network provider system 212 may be part of the enterprise network 224, and may be located behind a corporate firewall and connected to the wireless network gateway 210 through the Internet. A computer 222 (e.g., a desktop or laptop computer) belonging to the user of the handheld computer device 100 may be connected to the enterprise network 224. As described earlier, the handheld computer device 100 may be temporarily and directly connected to the computer 222 using, for example, the serial port 152. Alternatively, the handheld computer device 100 may communicate with the computer 222 using the communication subsystem 112 and the WAN 202 and/or the short-range communications subsystem 162 and the WLAN 204.

As shown in FIG. 6, one or more application/content servers 226 may be connected to the enterprise network 224 and also to another network, for example a Wide Area Network (WAN) 228. Content server(s) 226 and other network resources 230, etc., which may for example include any network resources such as e-commerce, e-learning, or other information sources, may provide content such as content 400 for display on device(s) 100.

In some embodiments, an email server 232 and/or the content server 226 may form part of the enterprise network 224. The WAN 228 may further connect to other networks. The WAN 228 may comprise or be configured with the Internet, a direct connection, a LAN, a wireless communication link, or any combination thereof. Content providers 226, such as Web servers, may be connected to the WAN 228, an example of which is shown in FIG. 6 as an origin server 230.

According to various embodiments, a mobile data delivery module 220 may provide connectivity between the wireless WAN 202 and the WLAN 204 and the other connection 206 and devices and/or networks connected directly or indirectly to the network provider system 212. In an embodiment, the connectivity provided may be Hypertext Transfer Protocol (HTTP) based connectivity providing an Internet based service connection for delivery of content 400 to devices 100 connected to the wireless WAN 202, the WLAN 204, or the other connection 206 and devices and/or networks connected directly or indirectly to the network provider system 212. The network 224, the application/content server 226, the WAN 228, and the origin server 230, may individually and/or collectively in various combinations act as a content source for the network provider system 212. It will be appreciated that the system shown in FIG. 6 comprises but one possible communication network or configuration of a multitude of possible configurations for use with the wireless devices 100.

The present disclosure is suitable for implementation using a variety of handheld, mobile, wireless or other devices 100, including for example cell phones and embedded devices that include an Internet enabled web browser on hardware of limited means. The present disclosure may be suitable for use with various devices having a small screen or limited screen 200 size (e.g., smaller than a conventional display screen on a desktop computer)

While the present disclosure has been described and illustrated in connection with specific, presently-preferred embodiments, many variations and modifications may be made without departing from the spirit and scope of the disclosure. The present disclosure is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. Selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

What is claimed is:

1. A method of displaying on a computer screen a portion of a web page or other interface display content, the method performed by a data processor and comprising:
accessing a data set representing display content for a computer interface screen;
mapping the accessed data set into a plurality of tiled content data sets;
selecting a portion of the tiled content data set to be rendered into tiled image data sets, the selected portion of the tiled content data set having a logical relationship with each other;
rendering the selected portion of the tiled content data set into a plurality of tiled image data sets;
storing the set of tiled image data sets in a memory controlled by the processor;
reading at least a portion of at least one of the stored tiled image data sets from the memory; and
displaying at least the portion of the at least one read tiled image data set on a display.

2. The method of claim 1, wherein the portion of the tiled content data set selected to be rendered is selected according to a static predefined logical relationship.

3. The method of claim 1, wherein the portion of the tiled content data set to be rendered is selected according to a dynamic logical relationship.

4. The method of claim 3, wherein the dynamic logical relationship is dynamically determined according to a prediction algorithm.

5. The method of claim 3, wherein the rendering is initiated following a predetermined time interval, and the dynamic logical relationship is dynamically determined during such interval.

6. The method of claim 1, wherein the display content data set is adapted for display in a size larger than a maximum size practicably displayable on the display.

7. The method of claim 1, further comprising:
in response to an input command signal received by the processor, causing the display to delete at least a portion of at least one displayed tiled image data set from its displayed location and re-display it in another location on the display.

8. The method of claim 1, wherein the plurality of tiled image data sets are stored sequentially in the memory, in a logical relationship corresponding to a relation in which they will be displayed.

9. The method of claim 1, comprising:
in accordance with a command signal received by the processor, deleting from the display at least a portion of at least one displayed image tile data set and displaying in its place placeholder data; and
following a predetermined wait period, if no subsequent contrary command signal is received, displaying in place of the placeholder data at least one previously-undisplayed portion of at least one tiled image data set accessed from the memory.

10. The method of claim 1, comprising:
in accordance with a command signal representing a zoom command received by the processor, deleting from the display at least a portion of at least one displayed tiled image data set, and displaying in its place at least a portion of at least one tiled image data set from a plurality of zoomed tiled image data sets;
wherein the zoomed tiled image data sets is generated by applying a zoom transfer to the accessed data set and re-mapping the zoomed accessed data set to a plurality of zoomed tiled content data sets and rendering a portion of the zoomed tiled content data set into the plurality of zoomed tiled image data sets.

11. A device for displaying a portion of a web page or other interface display content, the device comprising:
a display for displaying image data;
memory for storing image data; and
a processor configured to execute instructions to cause the device to:
access a data set representing display content for a computer interface screen;
map the accessed data set into a plurality of tiled content data sets;
select a portion of the tiled content data set to be rendered into tiled image data sets, the selected portion of the tiled content data set having a logical relationship with each other;
render the selected portion of the tiled content data set into a plurality of tiled image data sets;
store the set of tiled image data sets in the memory;
read at least a portion of at least one of the stored tiled image data sets from the memory; and
display at least the portion of the at least one read tiled image data set on the display.

12. The device of claim 11, wherein the portion of the tiled content data set selected to be rendered is selected according to a static predefined logical relationship.

13. The device of claim 11, wherein the portion of the tiled content data set to be rendered is selected according to a dynamic logical relationship.

14. The device of claim 13, wherein the dynamic logical relationship is dynamically determined according to a prediction algorithm.

15. The device of claim 13, wherein the rendering is initiated following a predetermined time interval, and the dynamic logical relationship is dynamically determined during such interval.

16. The device of claim 11, further comprising at least one user input device, wherein the processor is further configured to execute instructions to cause the device to:
in response to an input command signal received from the user input device, delete at least a portion of at least one displayed tiled image data set from its displayed location and re-display it in another location on the display.

17. The device of claim 11, wherein a plurality of undisplayed tiled image data sets are stored in a logical relationship corresponding to a relation in which they will be displayed.

18. The device of claim 11, wherein the processor is further configured to execute instructions to cause the device to:
in accordance with a command signal received by the processor, delete from the display at least a portion of at least one displayed image tile data set and display in its place placeholder data; and
following a predetermined wait period, if no subsequent contrary command signal is received, display in place of the placeholder data at least one previously-undisplayed portion of at least one tiled image data set accessed from the memory.

19. The device of claim 11, wherein the processor is further configured to execute instructions to cause the device to:
in accordance with a command signal representing a zoom command received by the processor, delete from the display at least a portion of at least one displayed tiled image data set, and display in its place at least a portion of at least one tiled image data set from a plurality of zoomed tiled image data sets;
wherein the zoomed tiled image data sets is generated by applying a zoom transfer to the accessed data set and re-mapping the zoomed accessed data set to a plurality of zoomed tiled content data sets and rendering a portion of the zoomed tiled content data set into the plurality of zoomed tiled image data sets.

20. Computer-readable programming product, the computer programming product having instructions tangibly encoded thereon to cause a data processor to:
access a data set representing display content for a computer interface screen;
map the accessed data set into a plurality of tiled content data sets;
select a portion of the tiled content data set to be rendered into tiled image data sets, the selected portion of the tiled content data set having a logical relationship with each other;
render the selected portion of the tiled content data set into a plurality of tiled image data sets;
store the set of tiled image data sets in the memory;
read at least a portion of at least one of the stored tiled image data sets from the memory; and
display at least the portion of the at least one read tiled image data set on the display.

21. The computer programming product of claim 20, wherein the portion of the tiled content data set selected to be rendered is selected according to a static predefined logical relationship.

22. The computer programming product of claim 20, wherein the portion of the tiled content data set to be rendered is selected according to a dynamic logical relationship.

23. The computer programming product of claim 22, wherein the dynamic logical relationship is dynamically determined according to a prediction algorithm.

24. The computer programming product of claim 22, wherein the rendering is initiated following a predetermined time interval, and the dynamic logical relationship is dynamically determined during such interval.

25. The computer programming product of claim 20, further comprising instructions adapted for causing the data processor to:
in response to an input command signal, delete at least a portion of at least one displayed tiled image data set from its displayed location and re-display it in another location on the display.

26. The computer programming product of claim 20, wherein a plurality of undisplayed tile data sets are stored sequentially in the memory in a logical relationship corresponding to a relation in which they will be displayed.

27. The computer programming product of claim 20, further comprising instructions adapted for causing the data processor to:
in accordance with a command signal received by the processor, delete from the display at least a portion of at least one displayed image tile data set and display in its place placeholder data; and
following a predetermined wait period, if no subsequent contrary command signal is received, display in place of the placeholder data at least one previously-undisplayed portion of at least one tiled image data set accessed from the memory.

28. The computer programming product of claim 27, further comprising instructions to cause the device to:
in accordance with a command signal representing a zoom command received by the processor, delete from the display at least a portion of at least one displayed tiled image data set, and display in its place at least a portion of at least one tiled image data set from a plurality of zoomed tiled image data sets;
wherein the zoomed tiled image data sets is generated by applying a zoom transfer to the accessed data set and re-mapping the zoomed accessed data set to a plurality of zoomed tiled content data sets and rendering a portion of the zoomed tiled content data set into the plurality of zoomed tiled image data sets.
